(19) United States
(12) Patent Application Publication
(10) Pub. No.: US 2013/0112080 A1
(43) Pub. Date: May 9, 2013

(54) System, Apparatus and Method for Degassing a Container

(71) Applicants: Jane Piper, Monterey, CA (US); Anthony Rutland, Freedom, CA (US); Joshua Salvage, Soquel, CA (US)

(72) Inventors: Jane Piper, Monterey, CA (US); Anthony Rutland, Freedom, CA (US); Joshua Salvage, Soquel, CA (US)

(73) Assignee: Piper Environmental Group, Inc., Castroville, CA (US)

(21) Appl. No.: 13/109,988

(22) Filed: May 17, 2011

Related U.S. Application Data
(60) Provisional application No. 61/346,233, filed on May 19, 2010.

(51) Int. Cl. B01D 19/00

(52) U.S. Cl. CPC B01D 19/0068
USPC 96/155; 96/193

(57) ABSTRACT

A variety of systems, apparatus and methods for degassing a container are described. A system comprises at least one input being configured to be coupled to a container to be degassed. A fluid output is configured to return fluid to the container. A degassing vessel comprises a top, a bottom, gas/fluid input being coupled to the at least one input, a degassed fluid output disposed proximate the bottom, and a gas output at the top. A pump system is coupled to the fluid output and the degassed fluid output. The pump system is configured to be operable for inducing a pressure differential between the degassing vessel and the container to induce a flow from the container to the degassing vessel and to return fluid to the container. A degas valve is coupled to the gas output for enabling entrained gas in the degassing vessel to be vented.

### CROSS-REFERENCE TO RELATED APPLICATIONS

The present Utility patent application claims priority benefit of the U.S. provisional application for patent Ser. No. 61/346,233 filed on May 19, 2010 under 35 U.S.C. 119(e). The contents of this related provisional application are incorporated herein by reference for all purposes to the extent that such subject matter is not inconsistent herewith or limiting hereof.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to fluids systems. More particularly, the invention relates to a system for removing entrained gas from a liquid.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Degas valves are utilized to remove gas from a liquid/gas dissolved mixture in a pressurized vessel or pipe that requires venting to atmosphere. One specific example of a dissolved gas in a liquid is water treatment utilizing ozone gas in a pressurized contact tank, vessel, or pipe. The reaction between the ozone gas and liquid being treated with ozone gas takes place in the contact tank, vessel, or pipe. The contact tank, vessel or pipe must be vented to prevent over pressurization and it also aids in the removal of bubbles in the liquid. The degas valve is typically mounted directly on top of the contact tank, vessel, or pipe. By moving the degas valve to the floor a height limiting factor affecting the contact tank, vessel, or pipe is eliminated. Other methods of degassing involve heating, vacuum, and sonication.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A and 1B illustrate an exemplary degassing system, in accordance with an embodiment of the present invention. FIG. 1A is a schematic view of the system, and FIG. 1B is a diagrammatic front view of a portion of the system;

FIG. 2 illustrates an exemplary degassing system, in accordance with an embodiment of the present invention;

FIG. 3 illustrates an exemplary degassing system, in accordance with an embodiment of the present invention; and

FIG. 4 illustrates an exemplary degassing system, in accordance with an embodiment of the present invention.

Unless otherwise indicated illustrations in the figures are not necessarily drawn to scale.

### SUMMARY OF THE INVENTION

To achieve the forgoing and other objects and in accordance with the purpose of the invention, a variety of systems, apparatus and methods for degassing a container are described.

In one embodiment a system comprises at least one input being configured to be coupled to a container to be degassed. A fluid output is configured to return fluid to the container. A degassing vessel comprises a top, a bottom, gas/fluid input being coupled to the at least one input, a degassed fluid output disposed proximate the bottom, and a gas output at the top. A pump system is coupled to the fluid output and the degassed fluid output. The pump system being configured to be operable for inducing a pressure differential between the degassing vessel and the container to induce a flow from the container to the degassing vessel and to return fluid to the container. A degas valve is coupled to the gas output for enabling entrained gas in the degassing vessel to be vented. In another embodiment the pump system further comprises a venturi for coupling to the degassed fluid output. In yet another embodiment the degassing vessel is further configured to comprise an elevation that is less than an elevation of the container. In still another embodiment the degassing vessel comprises a cylindrical shape. In another embodiment the pump system comprises a positive displacement pump for mitigating cavitations. In another embodiment the degassing vessel is further configured for mounting on a floor. In yet another embodiment the degas valve is further configured for mounting on a floor. In still another embodiment the degassing vessel, the pump system and the degas valve are further configured for mounting on a base. In another embodiment tops of the degassing vessel, the pump system and the degas valve are further configured for being at an elevation less than an elevation of a top of the container. In yet another embodiment the base is mountable to a floor. In still another embodiment the container is a vessel. In still another embodiment the container is a pipe.

In another embodiment an apparatus comprises a small vessel comprising a top, a bottom, at least one input being configured to accept an output from a top portion of a container to be degassed, a fluid output disposed proximate the bottom and being configured to return a fluid to the container, and a gas output at the top. The small vessel being configured to further comprise dimensions smaller than the container where an elevation of the top is substantially less than an elevation of the top portion. A degas valve is coupled to the gas output for enabling gas in the small vessel to be vented where a vent output of the degas valve is at an elevation less than the elevation of the top portion. A pump system is coupled to the fluid output and is configured to couple to the container. The pump system being configured to be operable to induce a pressure differential between the small vessel and the container where the pressure differential induces a flow from the at least one input to release entrained gas from the degas valve and return fluid to the container. In another embodiment the pump system comprises a positive displacement pump. In yet another embodiment the pump system further comprises a venturi for coupling to the fluid output. In still another embodiment the small vessel is further configured for mounting on a floor. In another embodiment the degas valve is further configured for mounting on a floor. In yet another embodiment the container is a vessel. In still another embodiment the container is a pipe.

In another embodiment a method comprises steps of mounting a system comprising a degassing vessel, a pump system and a degas valve below an elevation of a vessel or pipe requiring degassing. The method comprises coupling the degassing vessel and pump system to the vessel or pipe. The method comprises coupling the degas valve to the degassing vessel. The method comprises establishing a pressure differential between the degassing vessel and the vessel or pipe to enable a flow of entrained gas from the vessel or pipe and a return of fluid to the vessel or pipe. The method comprises enabling the entrained gas in the degassing vessel to vent through the degas valve.

Other features, advantages, and objects of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

A preferred embodiment of the present invention and at least one variation thereof provide a method for removing entrained gas from a liquid with a floor-mounted degas valve. Many preferred embodiments are implemented for removing entrained gas from a vessel or a pipe when the degassing device is mounted below the elevation of the vessel or the pipe. Many preferred embodiments comprise a pump, a venturi, a degas valve, and a small vessel.

An object of many preferred embodiments is to enable the degas valve to be installed away from the vessel or the pipe that it is degassing. Another object of many preferred embodiments is to allow for the degassing of tall vessels or pipelines where the maintenance of the degas valves may otherwise be difficult or dangerous. Yet another object of many preferred embodiments is to provide a system for removing entrained gas from a liquid that reduces the overall height of a vessel that needs to be degassed by allowing the degas valve to be mounted on or near the floor. This may be useful when the degas vessel is being used for both solubilizing a gas and acting as a contact vessel as it enables the full available height of the vessel to be used, and thus more volume may be added to the vessel.

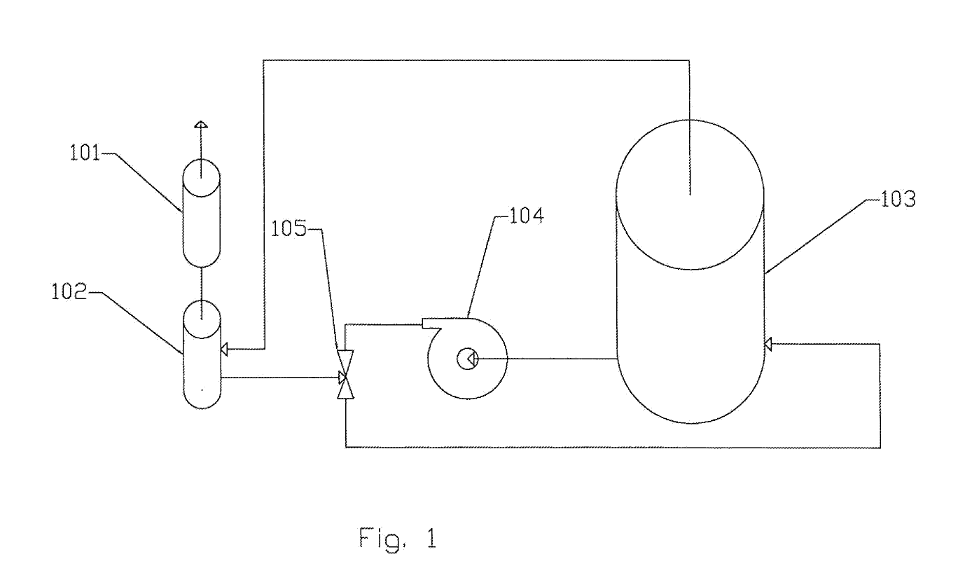

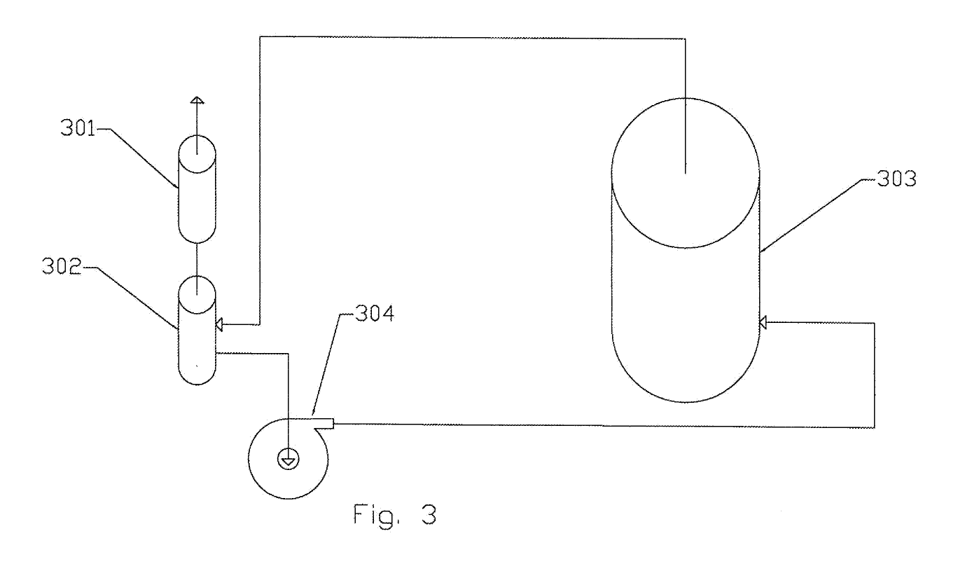

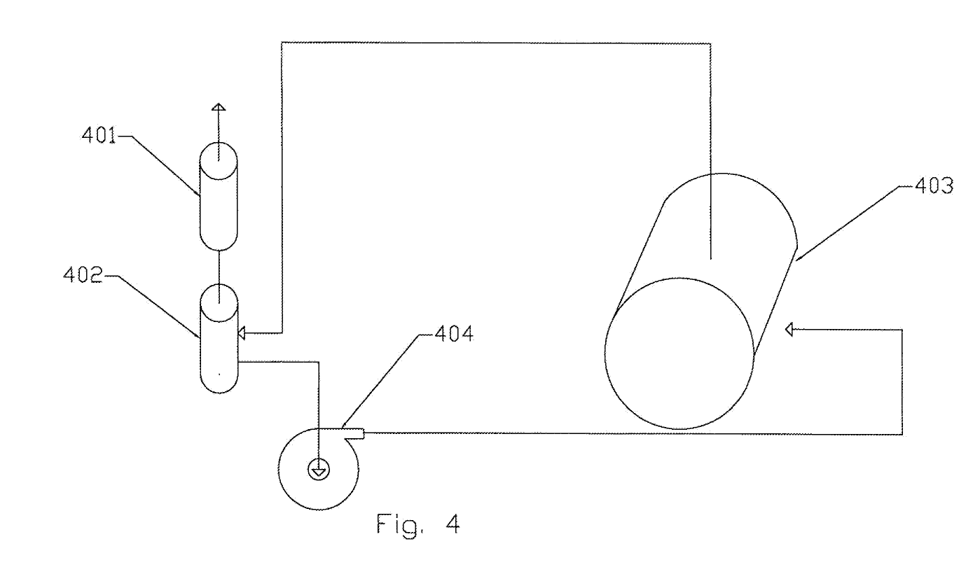

FIGS. 1A and 1B illustrate an exemplary degassing system, in accordance with an embodiment of the present invention. FIG. 1A is a schematic view of the system, and FIG. 1B is a diagrammatic front view of a portion of the system. In the present embodiment, the degassing system comprises a pump 104, a venturi 105, a degas valve 101, and a small vessel 102. The system is typically used to remove entrained gas from a liquid within a vessel 103. Degas valve 101 is installed in order to operate while located below the top level of vessel 103. Referring to FIG. 1B, degas valve 101 is shown mounted to the top of small vessel 102, which is mounted on the floor. Referring to FIG. 1A, pump 104 provides the motive force for venturi 105 to create a low pressure in small vessel 102 and initiate gas/liquid flow from the top of vessel 103 to small vessel 102. Pump 104 is used in conjunction with venturi 105; however, in alternate embodiments the pump may be used by itself to provide the motive force, as shown by way of example in FIGS. 3 and 4. The selection of pump 104 is often a function of the chemical properties of the gas/liquid mixture. Since venturi 105 is included, without limitation, in the present embodiment, the design of venturi 105 is also typically considered when choosing the design of pump 104. Those skilled in the art, in light of the present teachings, will readily recognize that a multiplicity of suitable pumps may be used in various embodiments of the present invention. For example, without limitation, the pump can be a centrifugal pump or a derivative of a centrifugal pump such as, but not limited to, pumps that are separately or closed coupled, pumps with open impellers or closed impellers, turbine pumps, etc. The pump may also be a positive displacement pump or a derivative of such including, without limitation, piston pumps, diaphragm pumps, peristaltic pumps, lobe pumps, gear pumps, screw pumps, progressive cavity pumps, etc. The pump may also be comprised of multiple components such as, but not limited to, a mechanical means for the pumping action and a separate means for powering the mechanical means. The powering means may be, but not limited to, an electric motor or other motive source coupled to the mechanical means with, but not limited to, a shaft, gears, pulleys, hydraulics, or combinations thereof, etc. Additionally, the powering means may be, but not limited to, configured to operate at a constant power level, may be configured to operate a various power levels, or may configured to operate at varying power levels under control from a digital or analog control system. Furthermore, a multiplicity of suitable materials may be used for the construction of the pump such as, but not limited to, various different metals or plastics depending on various factors including, but not limited to, how corrosive the gas/liquid mixture is, the flow rate of the system, the system operating pressure, etc.

In the present embodiment, venturi 105 creates a lower pressure in small vessel 102 than in vessel 103 being degassed. This pressure differential induces gas/liquid flow from the top of vessel 103. Venturi 105 may be a standard commercial or custom made venturi to be utilized in conjunction with pump 104 to provide the motive force to cause the gas/liquid mixture from the top of vessel 103 to small vessel 102. Those skilled in the art, in light of the present teachings, will readily recognize that venturis of various different shapes, sizes and configurations may be used in many embodiments of the present invention. The selection of the venturi is typically a function of the chemical properties of the gas/liquid mixture. Also, the pressure drop/flow across the venturi generally dictates the amount of vacuum developed at a vacuum port of the venturi, and the amount of gas/liquid mixture to be removed from vessel 103 typically determines the amount of vacuum needed at the throat of the venturi, and the amount of vacuum needed at the throat typically determines the size of the venturi. Furthermore, various different materials may be used for the construction of the venturi deepening on factors such as, but not limited to, the chemical properties of the gas/liquid mixture and the system operating pressure. Corrosive mixtures typically require materials such as, but not limited to, stainless steel or chemically compatible plastics. For non-corrosive mixtures the choices of materials are broader including, but not limited to, brass, bronze, cast iron, mild steel, plastics, etc. Systems with higher operating pressures may require the use of metals or reinforced plastics, and unreinforced plastics may be used for systems with lower operating pressures.

In the present embodiment, degas valve 101 is mounted near the floor and is utilized to relieve and vent the gas portion of the gas/liquid mixture while generally preventing the liquid within small vessel 102 from being vented to the atmosphere. Degas valves are commercially available devices of various sizes and materials. The selection of degas valve 101 is typically a function of the chemical properties of the gas/liquid mixture, if the degas valve is to continuously or occasionally vent gas and the pressure of the gas/liquid mixture. Commercial degas valves usually rely on float actuated valves to separate the gas from the liquid stream and are sensitive to the specific gravity of the liquid and the formation of foam, both of which can affect the operation of the degas valve. Custom degas valves may be used in some embodiments. Some embodiments may comprise custom degas valves under automated control that monitors, parameters such as, but not limited to, gas levels, pressures, specific gravity, etc.

The size and shape of small vessel 102 is typically a function of the amount of gas/liquid mixture to be degassed, if the degassing is continuous or sporadic and the pressure of the gas/liquid mixture. Those skilled in the art, in light of the present teachings, will readily recognize that the small vessel in various embodiments can take on many shapes such as, but not limited to, cylindrical, spherical, cubical, etc. In the present embodiment, small vessel 102 comprises three openings, an inlet, a gas outlet at the top and a liquid outlet at the bottom, which connects to the throat of venturi 105. In alternate embodiments where multiple vessels or pipes are being degassed, the small vessel can have multiple inlets. In other embodiments the multiple vessels or pipes may be individually selected either manually or under remote control. The selection of the construction material for the small vessel is often a function of the chemical properties of the gas/liquid mixture. Another design parameter that may be considered for the small vessel is the operating pressure of the overall system. This may dictate the method of construction and thickness of the materials to be used for the small vessel. The small vessel design is custom manufactured for each system utilizing off the shelf parts cut and welded together in order to meet the design requirements for each application of the invention. The vessel is constructed with an inlet and outlet on each end, and a discharge at the top for attachment of the degas valve.

In typical use of the present embodiment, the operation of degas valve 101 is based on the motive force provided by the combination of pump 104 and venturi 105. Pump 104 circulates liquid from vessel 103 through venturi 105. Venturi 105 creates a vacuum at its vacuum throat, which is connected to small vessel 102. This creates a pressure differential between small vessel 102 and vessel 103 to be degassed and induces a flow of the gas/liquid mixture that accumulates at the top of vessel 103 through a conveyance 106 such as, but not limited to, a pipe or tube into small vessel 102. In small vessel 102 the gas in the gas/liquid mixture separates from the liquid. The gas being lighter rises and is vented through degas valve 101 and the liquid being heavier sinks to the bottom of small vessel 102. The liquid leaves small vessel 102 through a conveyance 107 such as, but not limited to, a pipe or tube, and due to the lower pressure created at the throat of venturi 105 the liquid flow is induced into venturi 105. Once the liquid enters venturi 105, it mixes with the liquid circulating from vessel 103 by circulating pump 104 through conveyances 108 and 109 and this liquid returns to vessel 103 through a conveyance 110 to mix with the fluid in vessel 103.

Referring again to FIG. 1B, the overall height of vessel 103 to be degassed can be reduced with the use of floor mounted degas valve 101. Mounting small vessel 102 and degas valve 101 to the floor also enables vessel 103 to make use of the full available height within the confines of the particular system. The present embodiment can also be employed in a design application of an integrated system of limited height with a vessel needing to be degassed that would not allow the degas valve to be mounted on top of this vessel.

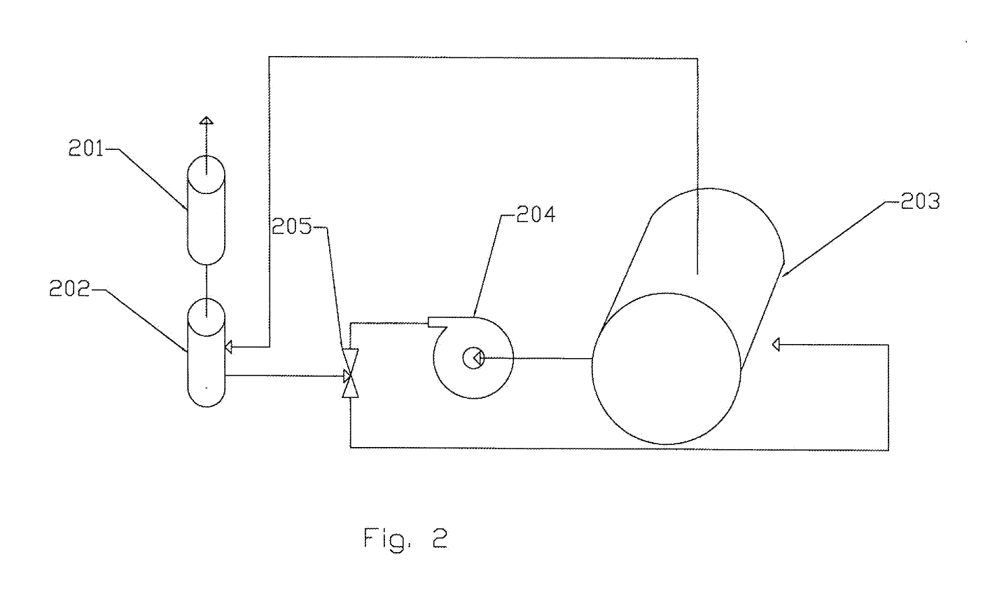

FIG. 2 illustrates an exemplary degassing system, in accordance with an embodiment of the present invention. In the present embodiment, a degas valve 201 is installed in order to operate while located below the top level of a pipe 203. The system comprises degas valve 201, a small vessel 202, a pump 204, and a venturi 205. The system is typically used to remove entrained gas from a liquid within pipe 203 and functions similarly to the embodiment shown by way of example in FIG. 1. Pump 204 provides the motive force for venturi 205 to create a low pressure in small vessel 202 and initiate gas/liquid flow from a high spot in pipe 203 through a conveyance 206 into small vessel 202 where the gas/liquid mixture is degassed. The gas is released through degas valve 201, and the liquid flows into venturi 205 through a conveyance 207. The liquid from small vessel 202 then combines with the flow of liquid being circulated from pipe 203 by pump 204 through conveyances 208 and 209 in venturi 205 and returns to pipe 203 through a conveyance 210 to mix with the liquid in pipe 203.

FIG. 3 illustrates an exemplary degassing system, in accordance with an embodiment of the present invention. In the present embodiment, the degassing system comprises a degas valve 301, a small vessel 202 and a pump 304. The system is typically used to remove entrained gas from a liquid within a vessel 303. Degas valve 301 is installed in order to operate while being below the top level of vessel 303. Pump 304 provides the motive force to create a low pressure in small vessel 302 and initiate gas/liquid flow from the top of vessel 303. Since no venturi is used, the design of pump 304 is typically driven by the amount of motive force required to move the gas/liquid mixture from vessel 303, and the type of pump chosen, for example, without limitation, centrifugal or positive displacement, is typically driven by the same requirement and the need to prime the system. A positive displacement pump is generally a good choice for pump 304, when the system does not utilize a venturi to provide the motive force for the gas/liquid mixture, as, during start up, a centrifugal pump may be subject to cavitations if the system is not properly primed.

In typical use of the present embodiment, the system operates similarly to the embodiment shown by way of example in FIG. 1; however, since no venturi is used, the fluid flow is induced into the inlet of pump 304 by the low pressure at this inlet, and the liquid is directly returned to vessel 303 from pump 304. By generating a low pressure within small vessel 302, pump 304 creates a pressure differential that induces the flow of the gas/liquid mixture from the top of vessel 303 through a conveyance 306 such as, but not limited to, a pipe or tube that is connected to small vessel 302. At small vessel 302 the gas separates from the liquid and is vented out degas valve 301, and the liquid exits the bottom of small vessel 302 back to pump 304 through a conveyance 307. Pump 304 returns the liquid to pipe 303 through a conveyance 310.

FIG. 4 illustrates an exemplary degassing system, in accordance with an embodiment of the present invention. In the present embodiment, the degassing system comprises a degas valve 401, a small vessel 402 and a pump 404. The system is typically used to remove entrained gas from a liquid within a pipe 403 with degas valve 401 installed below the top level of pipe 403. Pump 404 provides the motive force to create a low pressure in small vessel 402 and initiate gas/liquid flow from a high spot in pipe 403. In typical use of the present embodiment, the system operates similarly to the embodiment shown by way of example in FIG. 3. By generating a low pressure within small vessel 402, pump 404 creates a pressure differential that induces the flow of the gas/liquid mixture from a high spot in pipe 403 through a conveyance 406 such as, but not limited to, a pipe or tube that is connected to small vessel 402. At small vessel 402 the gas separates from the liquid and is vented out degas valve 401, and the liquid exits the bottom of small vessel 402 back to pump 404 through a conveyance 407. Pump 404 returns the liquid to pipe 403 through a conveyance 410.

Those skilled in the art, in light of the present teachings, will readily recognize that degassing systems in alternate embodiments may be implemented in a multiplicity of suitable arrangements. For example, without limitation, some alternate embodiments may comprise additional components such as, but not limited to, additional pumps, venturi injectors, small vessels, degas valves, vessels, etc. Some alternate embodiments may have the components in various different configurations. For example, without limitation, the conveyances may be connected to the components in various different locations or the degas valve and small vessel may be located in various different locations such as, but not limited to, on the floor, on the side of the vessel or pipe to be degassed, on various different components in the system, etc. In one alternate embodiment, the pump circulates water from the small vessel to the vessel or pipe to be degassed. The pump inlet creates a low pressure at its inlet, which is connected to the small vessel. This creates a pressure differential between the small vessel and the vessel or pipe to be degassed and induces a flow of gas/liquid mixture that accumulates at the high spot in the vessel or pipe into the small vessel. In the small vessel, the gas/liquid mixture separates; the gas being lighter rises and is vented through the degas valve, and the liquid being heavier sinks to the bottom of the small vessel. The pressure differential between the small vessel and the pump, which is low at the inlet of the pump and higher in the small vessel, induces the liquid to flow into the pump. The liquid from the small vessel is then sent to the vessel or pipe by the pump to mix with the fluid in the vessel or pipe.

In another alternate embodiment, the entire system is fabricated on a single base, with only two connection points on the system, plus the electric power for the pump. The inlet of the system is connected to the outlet at the top of the vessel or pipe to be degassed. The inlet of the system is where the gas/liquid mixture leaves the vessel or pipe to be degassed, and the outlet is where the degassed liquid is returned to the vessel or pipe. This single base system may be used with a venturi or without a venturi. The single base system may be configured to mount on a floor, attach to a side of the vessel or pipe, hang from the pipe, or any placed in any other available space.

In various other alternate embodiments manual control systems, automatic control systems, or combinations thereof may be utilized. Various analog or digital sensors such as, but not limited to, pressure sensors, vacuum sensors, flow sensors, gas sensors, temperature sensors, etc. may be used to monitor and or provide inputs to control systems. Some embodiments may further comprise controllable flow valves or pressure release valves. In some embodiments the operations of the pump may be controlled dependant on readings from various sensors. Other embodiments may also comprise alarm or warning systems to indicate operating parameters outside of safe limits. Still other embodiments may also comprise automated shutdown controls to prevent damage or dangerous situations.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of providing a degassing system according to the present invention will be apparent to those skilled in the art. The invention has been described above by way of illustration, and the specific embodiments disclosed are not intended to limit the invention to the particular forms disclosed. For example, the particular implementation of the system may vary depending upon the particular type of fluid mixture being degassed. The systems described in the foregoing were directed to gas/liquid implementations; however, similar techniques are to degas various different types of fluid mixtures such as, but not limited to, mixtures of gas and viscous liquids, gas/sludge mixtures, gas/particle mixtures, mixtures of multiple gasses, etc. Implementations of the present invention for use with various different types of mixtures are contemplated as within the scope of the present invention. The invention is thus to cover all modifications, equivalents, and alternatives falling within the spirit and scope of the following claims.

What is claimed is:

1. A system comprising:
at least one input being configured to be coupled to a container to be degassed;
a fluid output being configured to return fluid to the container;
a degassing vessel comprising a top, a bottom, gas/fluid input being coupled to said at least one input, a degassed fluid output disposed proximate said bottom, and a gas output at said top;
a pump system being coupled to said fluid output and said degassed fluid output, said pump system being configured to be operable for inducing a pressure differential between said degassing vessel and the container to induce a flow from the container to said degassing vessel and to return fluid to the container; and
a degas valve being coupled to said gas output for enabling entrained gas in said degassing vessel to be vented.

2. The system as recited in claim 1, in which said pump system further comprises a venturi for coupling to said degassed fluid output.

3. The system as recited in claim 1, in which said degassing vessel is further configured to comprise an elevation that is less than an elevation of the container.

4. The system as recited in claim 1, in which said degassing vessel comprises a cylindrical shape.

5. The system as recited in claim 1, in which said pump system comprises a positive displacement pump for mitigating cavitations.

6. The system as recited in claim 1, in which said degassing vessel is further configured for mounting on a floor.

7. The system as recited in claim 1, in which said degas valve is further configured for mounting on a floor.

8. The system as recited in claim 1, in which said degassing vessel, said pump system and said degas valve are further configured for mounting on a base.

9. The system as recited in claim 1, in which tops of said degassing vessel, said pump system and said degas valve are further configured for being at an elevation less than an elevation of a top of the container.

10. The system as recited in claim 8, in which said base is mountable to a floor.

11. The system as recited in claim 1, in which the container is a vessel.

12. The system as recited in claim 1, in which the container is a pipe.

13. An apparatus comprising:
a small vessel comprising a top, a bottom, at least one input being configured to accept an output from a top portion of a container to be degassed, a fluid output disposed proximate said bottom and being configured to return a fluid to the container, and a gas output at said top, said small vessel being configured to further comprise dimensions smaller than the container where an elevation of said top is substantially less than an elevation of the top portion;
a degas valve being coupled to said gas output for enabling gas in said small vessel to be vented where a vent output of said degas valve is at an elevation less than the elevation of the top portion; and
a pump system being coupled to said fluid output and being configured to couple to the container, said pump system being configured to be operable to induce a pressure differential between said small vessel and the container where said pressure differential induces a flow from said at least one input to release entrained gas from said degas valve and return fluid to the container.

14. The apparatus as recited in claim 13, in which said pump system comprises a positive displacement pump.

15. The apparatus as recited in claim 13, in which said pump system further comprises a venturi for coupling to said fluid output.

16. The apparatus as recited in claim 13, in which said small vessel is further configured for mounting on a floor.

17. The apparatus as recited in claim 13, in which said degas valve is further configured for mounting on a floor.

18. The apparatus as recited in claim 13, in which the container is a vessel.

19. The apparatus as recited in claim 13, in which the container is a pipe.

20. A method comprising steps of:
mounting a system comprising a degassing vessel, a pump system and a degas valve below an elevation of a vessel or pipe requiring degassing;
coupling said degassing vessel and pump system to the vessel or pipe;
coupling said degas valve to said degassing vessel;
establishing a pressure differential between said degassing vessel and the vessel or pipe to enable a flow of entrained gas from the vessel or pipe and a return of fluid to the vessel or pipe; and
enabling the entrained gas in said degassing vessel to vent through said degas valve.
